(19) United States
(12) Patent Application Publication
(10) Pub. No.: US 2013/0174924 A1
(43) Pub. Date: Jul. 11, 2013

(54) Fluid Circulation Module

(71) Applicants: Lingai Luo, Aix les Bains (FR); Yilin Fan, La Chapelle-sur-Erdre (FR)

(72) Inventors: Lingai Luo, Aix les Bains (FR); Yilin Fan, La Chapelle-sur-Erdre (FR)

(73) Assignees: UNIVERSITE DE SAVOIE, Chambery (FR); CENTRE NATIONAL DE LA RECHERCHE SCIENTIFIQUE, Paris (FR)

(21) Appl. No.: 13/810,556

(22) PCT Filed: Jul. 20, 2011
(86) PCT No.: PCT/EP11/62402

§ 371 Date: Mar. 20, 2013

(30) Foreign Application Priority Data
Jul. 20, 2010 (FR) FR10/03054

(51) Int. Cl. F17D 1/00

(52) U.S. Cl. CPC F17D 1/00
USPC 137/561 A

(57) ABSTRACT

The invention relates to a module for the circulation of fluids (A,B), comprising:—at least one fluid distribution plate (3,5) comprising a main open-ended fluid supply duct (11) produced in the plane of said plate (3,5) and secondary open-ended fluid distribution ducts produced at right angles to the plane of said plate (3,5) and connected to said main duct (11) by a branched circulation network,—at least one manifold unit (7) comprising circulation ducts (9) connected to said secondary ducts and parallel thereto, and at least one manifold plate (23) comprising a main open-ended fluid discharge duct (31) and manifold ducts produced at right angles to the plane of said plate (23) and connected to the circulation ducts (9) of said manifold unit (7) and to said main duct (31) by a branched circulation network.

The present invention concerns a multifunction fluid circulation module.

In energy systems such as systems for the production, transportation or storage of energy or other fluid management systems, serious problems have sometimes been encountered with overall dysfunctionality of the equipments of the energy system caused by a non-homogeneous distribution problem.

These equipments may be mixers, reactors and/or heat-exchangers. In reactors in particular the reaction heat of exothermic reactions must be evacuated or heat must be supplied for endothermic reactions. In this case, a third fluid operates as a heat-transfer fluid for improved control of the reaction operating conditions.

The temperature difference may be very small, however, and therefore very difficult to produce. It is therefore increasingly an aim to enhance performance, notably by intensifying the transfer of material and/or heat, at the same time as miniaturizing the system.

The present invention aims to alleviate these drawbacks of the prior art by proposing a compact circulation module with a homogeneous fluid distribution enabling intensification of material and/or heat transfer.

To this end, the invention consists in a module for the circulation of fluids characterized in that it comprises:
at least one fluid distribution plate comprising a main open-ended fluid feed duct produced in the plane of said plate and secondary open-ended fluid distribution ducts produced at right angles to the plane of said plate and connected to said main duct by a branched circulation network,
at least one manifold unit comprising circulation ducts connected to and parallel to said secondary ducts of said at least one plate, and
at least one manifold plate comprising a main open-ended fluid discharge duct and manifold ducts produced at right angles to the plane of said plate and connected on the one hand to the circulation ducts of said at least one manifold unit and on the other hand to said main duct by a branched circulation network.

Said module may further have one or more of the following features, separately or in combination:
said module includes at least one additional distribution plate interleaved between two manifold units and such that the secondary ducts of said at least one additional distribution plate are connected to the circulation ducts of said manifold units,
said module includes at least one first distribution plate and one second distribution plate and the secondary ducts of said distribution plates are connected to a mixing chamber of the second distribution plate, said mixing chamber being connected to the circulation ducts of said manifold unit so as to enable the mixing of said fluids,
said module includes at least two plates for distribution of fluids to be mixed and at least one heat-transfer fluid distribution plate and said at least one manifold, unit includes:
   first circulation ducts connected to the secondary ducts of said at least two distribution plates so as to enable the mixing of the fluids distributed by said plates, and
   second circulation ducts connected to the secondary ducts of the heat-transfer fluid distribution. plate, said first and second circulation ducts being luxtaposed so as to enable an exchange of heat between the mixed fluids distributed by said distribution plates and the heat-transfer fluid,
said module includes at least two plates for distribution of fluids to be mixed and at least one heat-transfer fluid distribution plate and said at least one manifold unit includes:
   first circulation ducts connected to the secondary ducts of said at least two distribution plates so as to enable the mixing of the fluids distributed by said plates, and
   second circulation ducts connected to the secondary ducts of the heat-transfer fluid distribution plate and surrounding the first circulation ducts so as to enable an exchange of heat between the mixed fluids distributed by said distribution plates and the heat-transfer fluid,
said module is configured to mix reactive fluids,
said module includes at least one first distribution plate and one second distribution plate and said at least one manifold unit includes:
   first circulation ducts connected to the secondary ducts of the first distribution plate, and
   second circulation ducts connected to the secondary ducts of the second distribution plate,
   said first and second circulation ducts being juxtaposed so as to enable an exchange of heat between the fluids distributed by said distribution plates,
said circulation ducts of said at least one manifold unit are substantially tubular,
said circulation ducts of said at least one manifold unit are substantially serpentine,
said module includes a plurality of distribution plates superposed on each other and on said at least one manifold unit and said interleaved plates include means for at least one fluid distributed by a fluid distribution plate of a higher stage to pass through,
said module includes sealing means between said superposed distribution plates,
the sealing means comprise interleaved sealing plates,
the branched structure of said distribution ducts reproduces the same channel configuration at each branching level,
said configuration is chosen from the group comprising a substantially T-shaped configuration, a substantiall X-shaped configuration and a substantially H-shaped configuration,
said at least one distribution plate has a branched structure comprising first branches arranged in accordance with a substantially H-shaped configuration and second branches arranged at the four ends of the first branches in accordance with the same substantially H-shaped configuration on a smaller scale,
said fluids circulate in a co-circulation mode, said fluids circulate in a contra-circulation mode,
said fluids circulate in a crossed-circulation mode.

Other features and advantages of the invention will emerge from the following description given by way of nonlimiting example with reference to the appended drawings, in which

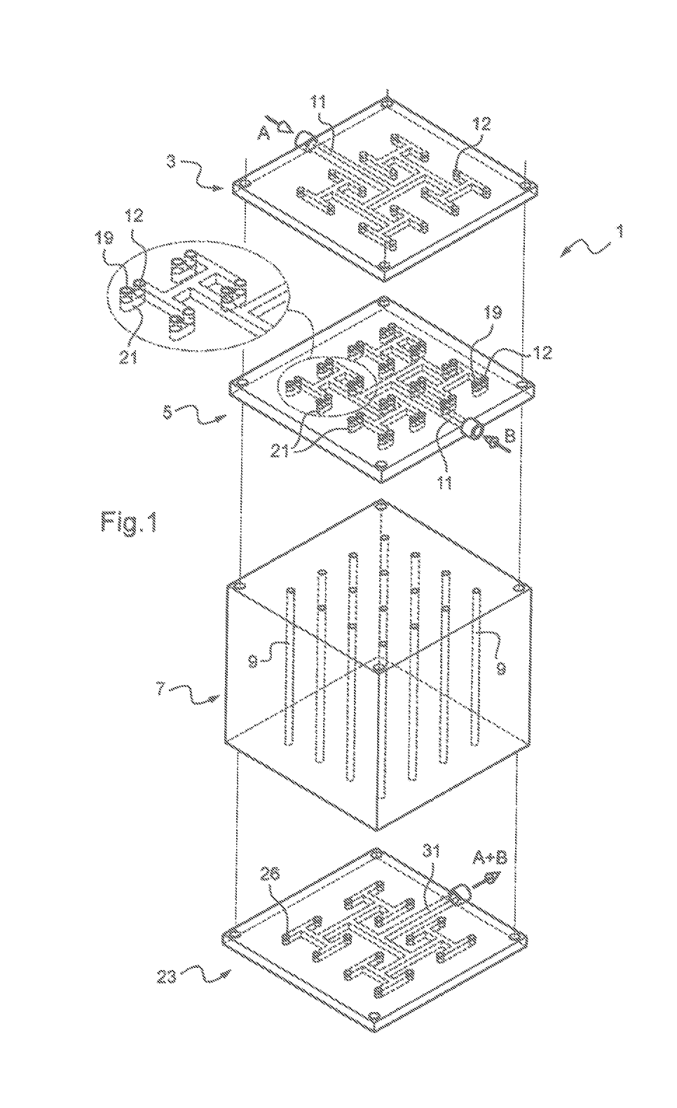

FIG. 1 represents diagrammatically a simplified perspective view of a module of a first embodiment,

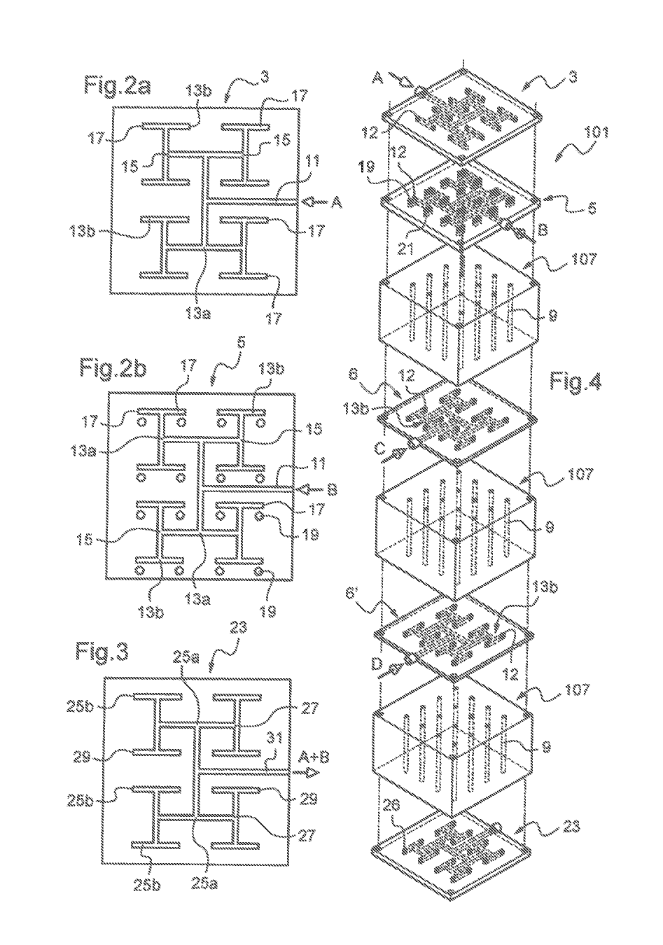

FIG. 2a represents one embodiment of a fluid distribution plate of the module from FIG. 1,

FIG. 2b represents one embodiment of another fluid distribution plate of the module from FIG. 1,

FIG. 3 represents one embodiment of a manifold plate of the module from FIG. 1,

FIG. 4 represents diagrammatically a multifluid module of a second embodiment,

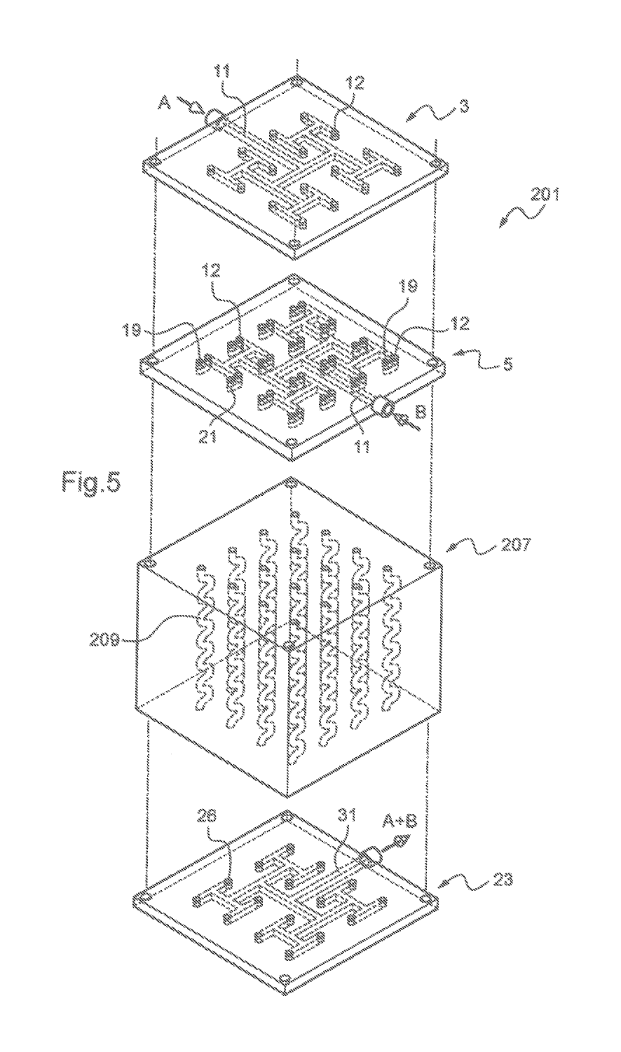

FIG. 5 represents diagrammatically a module of a third embodiment with serpentine manifold ducts,

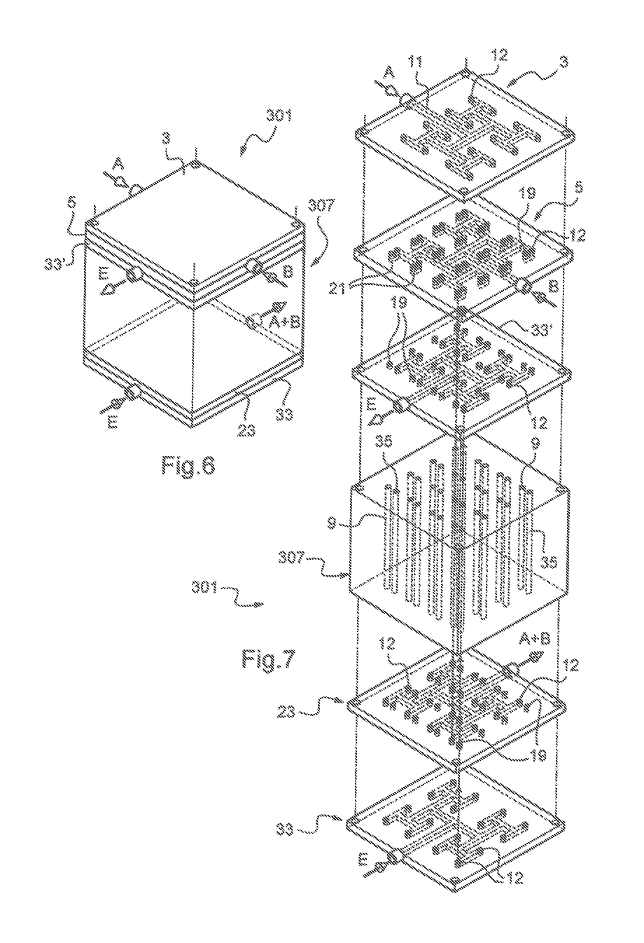

FIG. 6 represents diagrammatically a simplified plan view of a module of a fourth embodiment incorporating a fluid mixing and heat exchange function in parallel ducts,

FIG. 7 is an exploded view of the module from FIG. 6,

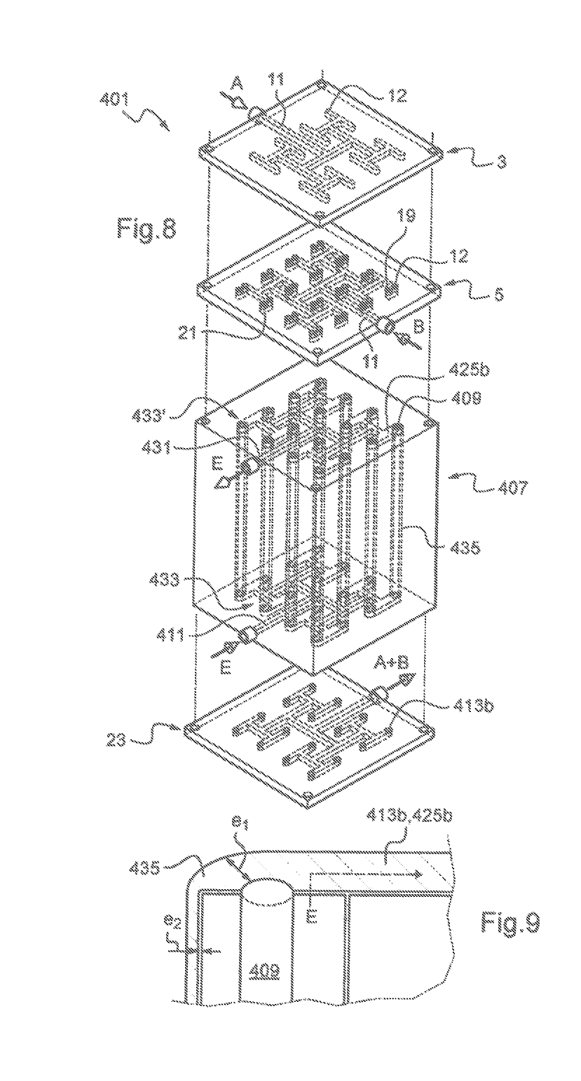

FIG. 8 represents diagrammatically a simplified perspective view of a module of a fifth embodiment combining a fluid mixing and heat exchange function in concentric ducts,

FIG. 9 is a partial view in section of a portion of the concentric ducts of the fifth embodiment from FIG. 8,

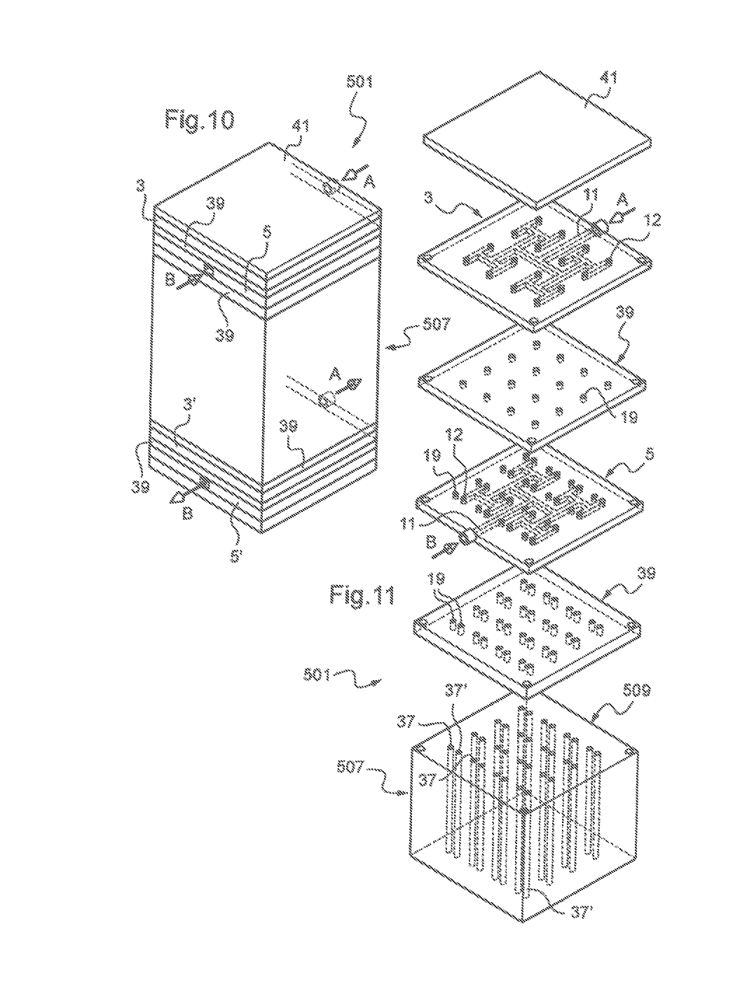

FIG. 10 is a perspective view of a module of a sixth embodiment providing a heat exchanger function. with no mixing of fluids,

FIG. 11 is an exploded view of the module from FIG. 10.

In the above figures and in the remainder of the description identical elements are identified by the same reference numbers. Elements from FIGS. 4 to 11 corresponding to elements from FIGS. 1 to 3 carry the same references preceded by a 1, 2, 3, 4 or 5 hundreds digit according to the embodiment.

### FIRST EMBODIMENT

### Mixing of Two Fluids

FIG. 1 is a simplified representation of a fluid circulation module 2 for mixing two fluids A and B, which may be reactive.

To this end, the module 1 includes a first distribution plate 3 for the first fluid A, a second distribution plate 5 for the second fluid B, and a manifold unit 7 for the two fluids A and B comprising ducts 9 for circulation and mixing of the distributed fluids A, B, these circulation ducts 9 being connected to the two distribution plates 3 and 5 so as to enable mixing of the two fluids A and B.

### Distribution Plates

The distribution plates 3, 5, seen better in FIGS. 2a and 2b, can he produced in glass, ceramic, plastic material or any other material. suitable for the application of the module 1 of the invention.

These plates may be produced by injection moldina, molding or assembling, for example gluing, two superposed half-plates.

In the FIG. 1 example, the two distribution plates 3 and 5 are arranged so that the two fluids A and B circulate in a contra-circulation mode, i.e. parallel and in opposite directions.

Obviously, defending on the application, there may be provision for circulation of the two fluids A and B in a co-circulation mode, i.e. parallel and in the same direction, or in a cross-circulation mode, i.e. at right angles.

Moreover, the two distribution plates 3 and 5 each have an open-ended main fluid circulation duct. Here this circulation duct is a fluid feed duct 11. The feed ducts 11 are connected to respective secondary distribution ducts 12 to feed each distribution plate 3, 5 with the fluid A or B.

If a plate 3, 5 is formed by assembling two superposed half-plates, there is etched or drilled in each half-plate one half of a main duct 11 and halves of a secondary duct 12 so as to form the complete ducts 11 and 12 on assembling the two half-plates.

For reasons of compactness, the feed ducts 11 are produced in the plane of the distribution plates 3, 5 and are open-ended laterally. This manner of producing the feed ducts 11 enables stacking of the distribution plates 3, 5 to form a compact module 1.

Obviously, at the level of the end plates of the module 1, for example the first distribution plate 3 for the first fluid A in this embodiment, the feed ducts 11 may be produced outside this plane because they do not impede the stacking of the distribution plates.

Furthermore, the secondary distribution ducts 12 are produced at right angles to the plane of the plates 3, 5 and are connected to the main duct and arranged in a branched structure (FIGS. 2a, 2b) comprising first branches 13a and second branches 13b.

To be more precise, a predefined number of first branches 13a are arranged in a substantially H-shaped configuration in this example. Other configurations may be envisaged, of course, for example an X-shaped configuration. The first branches 13a arranged in this way form the first level of the branched structure.

These first branches 13a then have four ends 15 in total. The second branches 13b are arranged at these ends 15. In order to obtain a homogeneous distribution of the fluids A, B, the second branches 13b are arranged in the same configuration, here an H-shaped configuration, as the first branches 13a. The second level of the branched structure is formed in this way, as is also, in this example, the last level.

At each descending level of the branched structure, the configuration of the branches 13b , here a substantially H-shaped configuration, is on a smaller scale compared to the scale for the ascending level. To put this clearly, the “H” formed by the first branches 13a is larger than the “H” formed by the second branches 13b

There are therefore four H-shaped configurations formed by the second branches 13h at the ends 15 of the first branches 13a.

The second branches 13b therefore have sixteen ends 17 in total for distributing the fluids A, B to the manifold unit 7. These ends 17 are all at the same level of the branched structure. Accordingly, whatever path is taken by the fluids A, B, it is the same at each end 17. This therefore ensures an equal division of the fluids A, B and thus a homogeneous distribution. At these ends 17 are the perpendicular secondary distribution ducts 12.

The number of final ends N connected to the collector unit 7 may he calculated from the following equation (1):

(1)

N=2^{m}

where m corresponds to the level of branching of the branched structure

For an X-shaped configuration the equation becomes:

(2)

N=4^{m}.

In the present example with two levels of an H-shaped branched structure, there are four divisions at the ends 15 of the first branches 13a and. there are therefore 2⁴ final ends 17, i.e. sixteen ends 17 to the second branches 13b.

Moreover, as can be seen in FIG. 1, the distribution plates 3 and 5 and the manifold unit 7 are superposed.

In this example, the distribution plate 3 for the first fluid A is on top and the distribution plate 5 for the second fluid B is interleaved between the first distribution plate 3 and the manifold unit 7.

In order to enable the circulation of the first fluid A to reach the manifold unit 7 the interleaved second distribution plate 5 includes means enabling the first fluid A to pass to the manifold unit 7, here orifices 19 (FIG. 2b).

Moreover, to guarantee the seal between these distribution plates 3 and 5, seals can be provided, for example, or a sealing material sprayed onto these distribution plates 3, 5, or sealing plates can be interleaved between the distribution plates 3, 5.

### Manifold Unit

As mentioned above, the manifold unit for its part includes circulation and mixing ducts 9 enabling mixing of the two fluids A and B produced in this embodiment in the form of parallel substantially tubular ducts (FIGS. 1 and 3). These circulation ducts 9 are parallel and in line with the secondary ducts 12 and therefore at right angles to the main ducts 11 of the distribution plates 3, 5.

As can be seen in FIG. 1, each mixing duct 9 is connected to a chamber 21 for mixing the first fluid A and the second fluid B connected to the distribution ducts 12 of the first distribution plate 3 and to the distribution ducts 12 of the second distribution plate 5. The mixing chamber 21 is formed in the second plate 5.

Moreover, the circulation and mixing ducts 9 can have very small dimensions, for example of the order of one millimeter, which enables intensification of the transfer of material and also a fast chemical reaction.

Furthermore, the fluids A and B being uniformly distributed in these circulation and mixing ducts 9, the quantity of fluid in each duct 9 can be small, which increases safety, notably in the case of toxic or explosive fluids.

To ensure that the mixing of or the reaction between the two fluids A and B is complete and/or to collect the mixture of the fluids A and B together, the module 1 further includes a manifold plate 23 (FIGS. 1, 3 and 4).

In the example shown in FIGS. 1 and 3, this manifold plate 23 is substantially identical to the distribution plates 3 and 5, i.e. it includes a plurality of distribution ducts 26 produced at right angles to the plane of the manifold plate 23 and connected by a branched structure to an open-ended main fluid circulation duct 31.

Like the distribution plates 3 and 5, the branched structure comprises first branches 25a arranged in an H-shaped configuration and second branches 25b arranged at the ends 27 of the first branches 25a, also in an H shaped configuration, and in turn have ends 29 at the level of which secondary ducts 26 are connected at right angles to the manifold plate 23. Referring to FIG. 1, it is these secondary channels 26 that are connected to the circulation and mixing ducts 9 of the manifold unit 7 to receive the mixture of the two fluids A and B.

Accordingly, the mixing of or the reaction between the two fluids A and B can be completed as the mixture passes through the branches 25a, 25b of the branched structure of the manifold plate 23.

The main fluid circulation duct serves in this case as an evacuation duct 31 for evacuating the mixture of the two fluids A and B, as shown by the arrow in FIG. 3 To this end, the first branches 25a of the branched structure are connected to this evacuation main duct 31.

For reasons of compactness, like the feed ducts 11, this evacuation duct 31 can be produced in the plane of the manifold plate 23 and can be open-ended laterally (cf. FIGS. 1 and 3).

A module 1 of this kind can therefore be very compact. Of course, for applications on a larger scale, a plurality of modules 1 can be assembled simply and quickly as required.

### SECOND EMBODIMENT

### Mixing of Four Fluids

FIG. 4 represents a second embodiment that differs from the first embodiment in that the module 101 enables mixing of four fluids A, B, C, D rather than only two fluids.

To this end, a new distribution plate 6, 6′ interleaved between two manifold units 107 is provided for each additional fluid C, D.

In this example the fluids c and D circulate in a co-circulation mode. On the other hand, the new distribution plates 6, 6′ are arranged for circulation in a cross-circulation mode between the additional fluids C, D and the first and second fluids A, B. Of course, the circulation of the third and fourth fluids C, D can be parallel to the circulation of the first fluid A and the second fluid B.

Like the distribution plates 3 and 5 (see FIGS. 2a and 4), these new distribution plates 6, 6′ include a fluid feed main duct 11 produced in the plane of the plate 6, 6′ and distribution secondary ducts 12 produced at right angles to the plane of the plate and connected to the main duct 11 by a branched structure comprising first branches 13a and second branches 13b arranged as described, above and reproducing the same configurations, here substantially H-shaped configurations.

In order to be able to mix these additional fluids C and D with the fluids A and B, the distribution plates 6 and 6′ are arranged so that the secondary ducts 12 are connected to the circulation and mixing ducts 9.

These distribution plates 6 and 6′ may alternatively be superposed with the distribution plates 3 and 5 before collection of the fluids in the circulation and mixing ducts 9. In this case, the interleaved distribution plates must include passage means for the fluids from the distribution plates situated above them in a similar manner to the orifices 19 of the second distribution plate 5 in FIG. 2b.

In this example, four fluids A to D are distributed and mixed; of course, as many fluids and thus as many fluid distribution plates as necessary can be added.

Accordingly, the module 101 can be adapted. simply and quickly according to the application by adding or removing fluid distribution plates 3, 5, 6, 6′.

### THIRD EMBODIMENT

Mixing with Serpentine Duets

FIG. 5 shows a third embodiment of the module 201 which differs from the first embodiment in that the circulation and mixing ducts 209 of the manifold unit 207 are produced with serpentine shapes so as to increase the time spent in the ducts 209 and to ensure more complete mixing of or a more complete reaction between the two fluids A and B.

### FOURTH EMBODIMENT

### Mixing and Heat Exchange in Parallel Ducts

FIGS. 6 and 7 show a fourth. embodiment of the module 301 that differs from the first embodiment in that the module 301 incorporates a heat-exchange function in addition to the fluid-mixing function.

To this end, a heat-transfer fluid B is distributed by a distribution plate 33 analogous to that of the fluids A and B connected to the circulation ducts 35 for the heat-transfer fluid juxtaposed with the circulation and mixing ducts 9 (see FIG. 7). In this case, the manifold it 307 includes a plurality of pairs of juxtaposed ducts, each pair comprising a circulation and mixing duct 9 for the two fluids A and B and a circulation duct 35 for the heat-transfer fluid B only. These circulation ducts 9 and 35 have small dimensions to intensify the transfer of heat.

The distribution plate 33 for the heat-transfer fluid B is for example disposed under the manifold unit 307 or the manifold plate 23. In the latter case, the manifold plate 23 includes means for the heat-transfer fluid B to pass through, such as orifices 19.

A manifold plate 33′ analogous to the manifold plate 23 can be arranged under the distribution plates 3 and 5 for the first and second fluids A and B to evacuate the heat-transfer fluid B from the module 301.

Given the position of this manifold plate 33′ for evacuation of the heat-transfer fluid B, it obviously includes passage means such as respective orifices 19 enabling circulation of the fluids A and B to the manifold unit 307.

This additional heat-exchange function of the module 301, necessitating no additional equipment or connection, is advantageous for producing isothermal operating conditions for the mixing of the two fluids A and B, for example.

### FIFTH EMBODIMENT

### Mixing and Heat Exchange in Concentric Ducts

In a fifth embodiment shown in FIG. 8 the exchange of heat is effected by circulation of the heat-transfer fluid E in circulation ducts 435 of the manifold unit 407 surrounding the mixing ducts 409 rather than in parallel ducts as in the fourth embodiment. The ducts 409 and 435 have small dimensions to intensify the transfer of heat.

To this end, the distribution plate 433 for the heat-transfer fluid E forms an integral part of the manifold unit 407 and likewise the manifold plate 433′ for evacuation of the heat-transfer fluid E forms an integral part of the manifold unit 407.

The mixing ducts 409 are ducts produced at right angles to the plates 433 and 433′ and are connected to the mixing chambers 21 of the second plate 5.

The circulation ducts 435 they form the secondary ducts produced at right angles to the plates 433 and 433′ and connected by a branched structure on the one hand to the heat-transfer fluid feed duct 411 and on the other hand to the heat-transfer fluid evacuation duct 431, These circulation ducts 435 have a diameter greater than the diameter of the mixing ducts 409 so as to be able to surround the mixing ducts 409.

Moreover, as can be seen better in FIG. 9, the circulation ducts 435 have a first thickness e1 where they are connected to the branched structure, to be more precise to the second branches 413b in the case of the distribution plate 433 or the second branches 425b in the case of the manifold plate 433, and a second thickness e2 along the manifold unit 407.

The first thickness e1 of a circulation duct 435 is chosen so that the interior mixing duct 409 is in contact with the circulation duct 435 to enable fixing of the two ducts by gluing or welding, for example.

The second thickness e2 of a circulation. duct 435 is made smaller than the first thickness e1 so that the two ducts 409 and 435 are no longer in contact to allow the heat-transfer fluid B to circulate around the interior mixing duct 409.

### SIXTH EMBODIMENT

### Heat Exchange

FIGS. 10 and 11 show a sixth embodiment that differs from the fourth embodiment in that the module 501 allows exchange of heat between the fluids A and B without integrating the mixer function. In this case, one of the fluids A, B is a heat-transfer fluid.

To this end, the circulation ducts 509 of the manifold unit 507 collect each fluid A, B separately and not together as described above.

To this end the circulation ducts 509 include juxtaposed first circulation ducts 37 and second, circulation ducts 37′. The first circulation ducts 37 are exclusively dedicated to the first fluid A and the second circulation ducts 37′ are exclusively dedicated to the second fluid B. No mixing of the two fluids A and B occurs.

Moreover, once the exchange of heat has been effected the fluids A and B may be evacuated from the module 501 via respective additional manifold plates 3′, 5′ analogous to the manifold plate: 21 (FIG. 3) and arranged after the manifold unit 507. This additional manifold plate 3′, 5′ includes manifold ducts connected to the respective circulation ducts 37 and 37′ of the manifold unit 507; evacuation is effected via the fluid evacuation duct 31 (cf. FIGS. 3 and 9).

Moreover, as can be seen in FIGS. 10 and 11, interleaved sealing plates 39 can be provided. These interleaved plates 39 therefore each include means, such as orifices 19, for each fluid A, B distributed by a distribution plate 3, 5 above it to pass through.

A plate 41 for protecting the module 501 can also be provided.

In conclusion, for greater clarity, various embodiments have been described separately but it is obvious that these various embodiments can be combined in accordance with the requirements of the application.

For example, a distribution module can be provided enabling mixing of more than two fluids in accordance with the second embodiment comprising serpentine manifold and mixing ducts in accordance with the third embodiment and integrating a heat-exchange function in accordance with the fourth or fifth embodiment.

Thus there is obtained a module of small size and reduced cost able to combine distributor, manifold, mixer, reactor and thermal-exchanger functions and enabling homogeneous distribution of a plurality of fluids, complete mixing, intensified transfer of material or heat, low head losses and small temperature differences.

1. A module for the circulation of fluids, the module comprising:
at least one fluid distribution plate comprising a main open-ended fluid feed duct produced in the plane of said plate, and secondary open-ended fluid distribution ducts produced at right angles to the plane of said fluid distribution plate and in fluid communication with said main open-ended fluid feed duct by a branched circulation network,
at least one manifold unit comprising circulation ducts in fluid communication with and parallel to said secondary open-ended fluid distribution ducts of said at least one fluid distribution plate, and
at least one manifold plate comprising a main open-ended fluid discharge duct and manifold ducts produced at right angles to a plane in which lies the main open-ended fluid discharge duct of said manifold plate and in fluid communication on the one hand to the circulation ducts of said at least one manifold unit and also in fluid communication with said main open-ended fluid discharge duct through a branched circulation network.

2. A module as claimed in claim 1, comprising at least one additional distribution plate interleaved between two manifold units and such that the secondary ducts of said at least one additional distribution plate are in fluid communication with the circulation ducts of said manifold units.

3. A module as claimed in claim 1 wherein:
said module includes at least one first distribution plate and one second distribution plate, and
the secondary ducts of said distribution plates are in fluid communication with a mixing chamber of the second distribution plate, said mixing chamber being in fluid communication with the circulation ducts of said manifold unit so as to enable the mixing of said fluids.

4. A module as claimed in claim 1 wherein said module includes at least two distribution plates for fluids (A, B) to be mixed and at least one distribution plate for the heat-transfer fluid (E) and in that said at least one manifold unit includes:
first circulation ducts in fluid communication with the secondary ducts of said at least two distribution plates so as to enable the mixing of two fluids distributed by said two distribution plates, and
second circulation ducts in fluid communication with the secondary ducts of the distribution plate for a heat-transfer fluid,
said first circulation ducts and second circulation ducts being juxtaposed so as to enable an exchange of heat between the two mixed fluids distributed by said two distribution plates and the heat-transfer fluid.

5. A module as claimed in claim 1 wherein said module includes at least two distribution plates for two fluids (A, B) to be mixed and at least one distribution plate for a heat-transfer fluid (E) and in that said at least one manifold unit includes:
first circulation ducts in fluid communication with the secondary ducts of said at least two distribution plates so as to enable the mixing of the fluids (A, B) distributed by said plates, and
second circulation ducts in fluid communication with the secondary ducts of the distribution plate for the heat-transfer fluid (E) and surrounding the first circulation ducts (439)-so as to enable an exchange of heat between the mixed fluids (A, B) distributed by said distribution plates and the heat-transfer fluid (E).

6. A module as claimed in claim 3 wherein said fluids are reactive fluids.

7. A module as claimed in claim 1 wherein the module includes at least one first distribution plate and one second distribution plate and in that said at least one manifold unit includes:
first circulation ducts in fluid communication with the secondary ducts of the first distribution plate, and
second circulation ducts in fluid communication with the secondary ducts of the second distribution plate,
said first circulation ducts and second circulation ducts being juxtaposed so as to enable an exchange of heat between fluids distributed by said distribution plates.

8. A module as claimed in claim 1 wherein said circulation ducts of said at least one manifold unit are substantially tubular.

9. A module as claimed in claim 1 wherein said circulation ducts of said at least one manifold unit are substantially serpentine.

10. A module as claimed in claim 1 wherein the module includes a plurality of distribution plates superposed on each other and on said at least one manifold unit and in that said interleaved plates include means for at least one fluid distributed by a fluid distribution plate of a higher stage to pass through.

11. A module as claimed in claim 10, further comprising sealing means between said superposed distribution plates.

12. A module as claimed in claim 11, wherein said sealing means comprise interleaved sealing plates.

13. A module as claimed in claim 1 wherein said branched circulation network comprises a branched structure which reproduces a same configuration at each branching level.

14. A module as claimed in claim 13, the configuration for the, branch structure in said branched circulation network is chosen from the group comprising:
a substantially T-shaped configuration;
a substantially X-shaped configuration; and
a substantially H-shaped configuration.

15. A module as claimed in claim 14, wherein the branched circulation network of at least one distribution plate has a branched structure comprising first branches arranged in accordance with a substantially H-shaped configuration and second branches arranged at four ends of the first branches in accordance with the same substantially H-shaped configuration on a smaller scale.

16. A module for the circulation of fluids, the module comprising:
at least one fluid distribution plate, each of said at least one fluid distribution plates having a fluid feed duct provided in a plane of said respective at least one fluid distribution plate and each of said at least one fluid distribution plates having a secondary open-ended fluid distribution ducts provided therein with each of the secondary open-ended fluid distribution ducts in fluid communication with at least one fluid feed duct;
at least one manifold unit having one or more circulation ducts provided therein, each of the one or more one or more circulation ducts in fluid communication with secondary open-ended fluid distribution ducts of at least one of said at least one fluid distribution plates; and
at least one manifold plate, each of said at least one manifold plates having a main open-ended fluid discharge duct in a plane thereof and each of said at least one manifold plates also having provided therein at least one distribution duct in fluid communication with at least some of the one or more circulation ducts of said at least one manifold unit and also in fluid communication with the main open-ended fluid discharge duct of the at least one manifold plate.

17. The module recited in claim 16 wherein each of said at least one fluid distribution plates is provided having a branched fluid circulation network which provides a fluid communication path between the open-ended fluid distribution ducts and the at least one fluid feed duct

18. The module recited in claim 16 wherein each of said at least one manifold plates is provided having a branched fluid circulation network which provides a fluid communication path between the at least one fluid distribution ducts in the at least one manifold plate and the main open-ended fluid discharge duct of the at least one manifold plate.

19. The module recited in claim 16 wherein:
the secondary open-ended fluid distribution ducts provided in each of said at least one fluid distribution plates are provided at an angle perpendicular to the plane of in which lies the fluid feed duct of the respective one of each of said at least one fluid distribution plates; and
the at least one distribution duct provided in each of said at least one manifold plates are provided at an angle perpendicular to the plane of said manifold plate in which lies the main open-ended fluid discharge duct of the at least one manifold plate.

20. The module recited in claim 16 wherein the module includes a plurality of distribution plates superposed on and in fluid communication with each other with at least one of said plurality of distribution plates disposed on and in fluid communication with said at least one manifold unit.
